(19) United States
(12) Patent Application Publication
(10) Pub. No.: US 2014/0069463 A1
(43) Pub. Date: Mar. 13, 2014

(54) PARTICLE DETECTION AND CLEANING SYSTEM

(71) Applicants: James Coyne, Newburgh, NY (US); Joseph D. Fernandez, Verbank, NY (US); William W. Harkins, Montgomery, NY (US); Christos Theodore Kapogiannis, Pleasant Valley, NY (US)

(72) Inventors: James Coyne, Newburgh, NY (US); Joseph D. Fernandez, Verbank, NY (US); William W. Harkins, Montgomery, NY (US); Christos Theodore Kapogiannis, Pleasant Valley, NY (US)

(73) Assignee: INTERNATIONAL BUSINESS MACHINES CORPORATION, ARMONK, NY (US)

(21) Appl. No.: 13/606,071

(22) Filed: Sep. 7, 2012

(51) Int. Cl. B08B 7/04; B25J 11/00; B25J 19/02; A47L 5/14

(52) U.S. Cl. 134/18; 134/137; 15/345; 15/21.1; 134/32; 414/222.01

(57) ABSTRACT

A system including a shuttle movable along a shuttle path, the shuttle being operable to support a sheet; a pick-up assembly including a yoke and a detection plate located above the shuttle path, the detection plate being freely supported by the yoke and movable in a vertical direction relative to the yoke with an upper limit and a lower limit defined by the yoke, wherein the yoke is operable to pick and place the sheet, and wherein the detection plate is used to detect the presence of a piece of debris on a surface of the sheet or a surface of the shuttle; and a cleaning device located adjacent to the pick-up assembly and above the shuttle path, wherein the cleaning device is operable to remove the piece of debris located on the surface of the sheet or the surface of the shuttle.

### BACKGROUND

1. Field of the Invention

This invention relates to a system for detecting particulate contaminants associated with ceramic sheets during processing in the manufacture of integrated circuits.

2. Background of Invention

In the manufacture of integrated circuits, unfired ceramic sheets (hereinafter “green sheets”) are subjected to a variety of processing techniques, such as blanking, punching, screening with a conductive paste, and stacking into multilayer modules. The green sheets are generally flexible and soft until fired. They have a propensity to carry with them particulate contaminants, typically ceramic debris, which tend to adhere to their soft surfaces. These contaminants may be carried with the green sheets from station to station since handling is generally by vacuum pick-up or Bernouilli techniques. Thus, at those stations where debris is likely to be created, such as in blanking and punching of the green sheet material, it is difficult to eliminate all contaminants when the sheets are moved to the next processing station.

The existence of these contaminants is especially severe during processing to screen a conductive paste pattern on the green sheet. During this process step, a thin mask may be placed over the green sheet wafer for the purpose of screening a highly complex and fine pattern of conductive lines. The presence of such contaminants has a twofold effect. First, they may cause dents in the mask during screening resulting in the destruction of the mask and poor dimensional control of the screened pattern. In the formation of integrated circuits, layers of green sheets may be stacked to define a multi-layer ceramic module. Alignment from layer to layer is crucial and the existence of a dent caused by a particle may destroy the conductive alignment in the mask which is used to screen conductive paste on that respective green sheet. As a result, the damaged mask must be discarded.

Secondly, the presence of a contaminant inhibits effective screening of the conductive pattern. In the absence of a test to determine whether particles are present, screening takes place and it is only in subsequent quality control steps that the accuracy of the screening procedure is determined. Should the screening be defective, the sheets are generally unusable. Thus, in addition to destroying the mask, defective green sheets are produced.

### SUMMARY

According to one embodiment of the present invention, a system is provided. The system may include a shuttle movable along a shuttle path, the shuttle being operable to support a sheet; a pick-up assembly including a yoke and a detection plate located above the shuttle path, the detection plate being freely supported by the yoke and movable in a vertical direction relative to the yoke with an upper limit and a lower limit defined by the yoke, wherein the yoke is operable to pick and place the sheet, and wherein the detection plate is used to detect the presence of a piece of debris on a surface of the sheet or a surface of the shuttle; and a cleaning device located adjacent to the pick-up assembly and above the shuttle path, wherein the cleaning device is operable to remove the piece of debris located on the surface of the sheet or the surface of the shuttle.

According to another exemplary embodiment, a method is provided. The method may include cleaning a shuttle by moving the shuttle along a shuttle path below a cleaning assembly; placing a sheet on the shuttle using a pick-up assembly comprising a detection plate; the detection plate being freely supported by a yoke and movable in a vertical direction relative to the yoke with an upper limit and a lower limit defined by the yoke; cleaning the sheet by moving the shuttle with the sheet along the shuttle path below the cleaning assembly; and checking for debris by lowering the pick-up assembly and resting the detection plate on the sheet.

### BRIEF DESCRIPTION OF THE SEVERAL VIEWS OF THE DRAWINGS

The following detailed description, given by way of example and not intend to limit the invention solely thereto, will best be appreciated in conjunction with the accompanying drawings, in which:

FIG. 1 illustrates a pick-up head assembly and a nest assembly according to one embodiment.

FIG. 2 illustrates the sensor set position of the pick-up head assembly according to one embodiment.

FIG. 3 illustrates debris detection using the pick-up head assembly according to one embodiment.

FIG. 4 illustrates a cleaning device according to one embodiment.

FIG. 4A illustrates a cleaning device according to one embodiment.

FIG. 5 illustrates a cross-sectional view of FIG. 4.

FIGS. 6A-6G illustrate the steps of a method of cleaning and detecting debris according to one embodiment.

FIG. 6A illustrates moving a shuttle from the input station to the load station and raising the detection plate according to one embodiment.

FIG. 6B illustrates picking up a greet sheet according to one embodiment.

FIG. 6C illustrates moving the shuttle from the load station back to the input station and cleaning the nest assembly as it moves under the cleaning device from the screen station to the load station according to one embodiment.

FIG. 6D illustrates depositing the green sheet on the nest assembly at the load station according to one embodiment.

FIG. 6E illustrates cleaning the surface of the green sheet as the nest assembly moves from the load station to the screen station and back the load station while passing under the cleaning device according to one embodiment.

FIG. 6F illustrates a debris detection sequence without the presence of debris according to one embodiment.

FIG. 6G illustrates a debris detection sequence with the presence of debris according to one embodiment.

The drawings are not necessarily to scale. The drawings are merely schematic representations, not intended to portray specific parameters of the invention. The drawings are intended to depict only typical embodiments of the invention. In the drawings, like numbering represents like elements.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

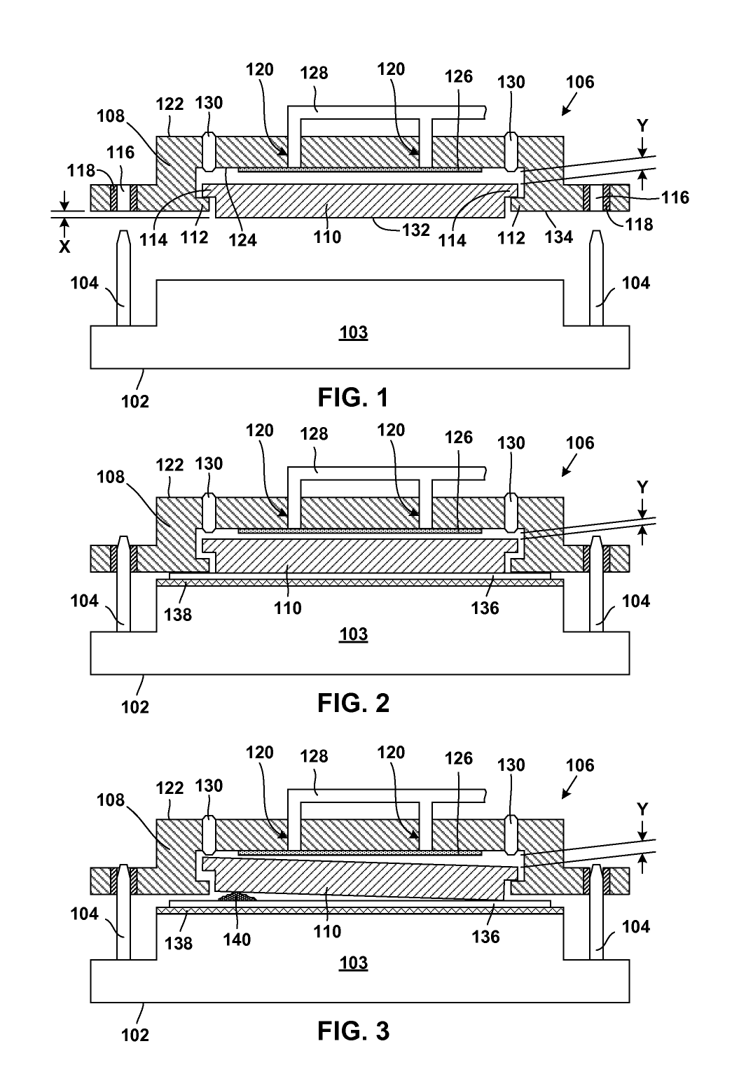

Referring now to FIGS. 1-5, one embodiment of the present invention is shown. As set forth herein, a function of this invention is to determine the presence of particles which adhere to either the pick-up head or nest surfaces which would result in either damage to screening masks or result in defective screening.

Now referring to FIG. 1, a nest assembly 102 generally including a fixture 103 having a plurality of locating pins 104. While two such pins are shown, it may be understood that any number of pins can be used to achieve accurate alignment of the system. The nest assembly 102, as shown in FIG. 1, may be used as an operation point in the processing of green sheets. A pick-up head assembly 106 may be used to move green sheets between processing stations. The pick-up head assembly 106 may use vacuum or Bernouilli principles to lift, support, and transfer a green sheet during processing. The pick-up head assembly 106 may include a yoke 108 and a detection plate 110. The yoke 108 may include inward facing flanges 112 which may support corresponding outward facing flanges 114 on the detection plate 110. The detection plate 110 may be approximately 8 in square, 9/32 in thick, and weight about 5 lbs. The detection plate 110 may move freely, or float, within the confines of the yoke 108. The yoke 108 may also include alignment holes 116 suitably fitted with a sleeve 118 to reduce friction and provide accurate alignment of the pick-up head assembly 106, vis-a-vis the plurality of locating pins 104.

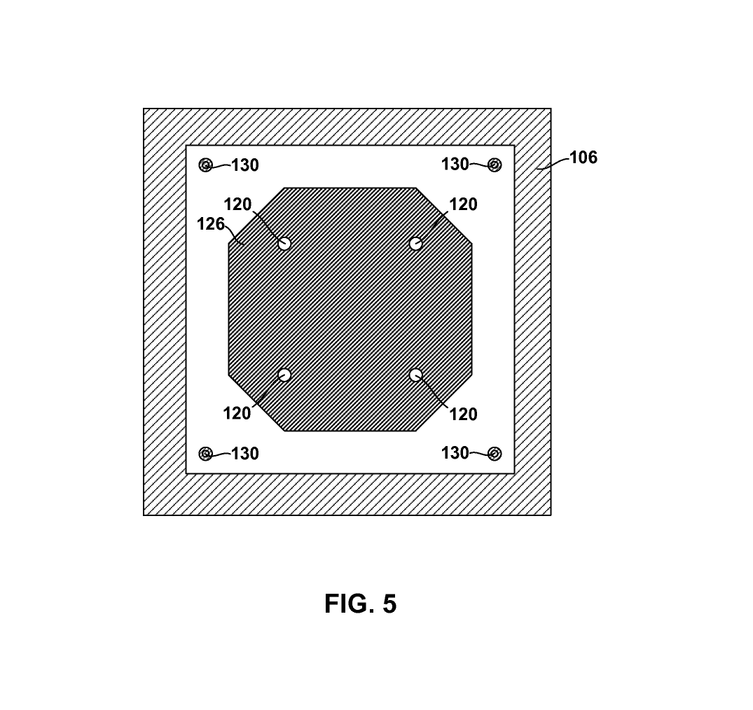

A series of pneumatic ports 120 may extend from an outer surface 122 to an inner surface 124 of the yoke 108. The pneumatic ports 120 in combination with a film chamber 126 may be used to raise the detection plate 110 within the yoke 108. While only two pneumatic ports are illustrated by the cross-sectional view in the figures, it may be understood that any number of pneumatic ports can be used to achieve sufficient vacuum lifting capacity required. In one embodiment, four pneumatic ports may be used to achieve sufficient vacuum lifting capacity (shown in FIG. 5). The pneumatic ports 120 may be fitted to the film chamber 126 located adjacent to the inner surface 124 of the yoke 108. The film chamber 126 may be, for example, Mylar. The pneumatic ports 120 may be connected to a hose 128 which may provide either compressed air, vacuum, or both to the film chamber 126 via the pneumatic ports 120.

A series of sensors 130 may be fitted in the yoke 108. The sensors 130 may be used to determine the relative position of the detection plate 110 to the yoke 108. It is apparent that any number of sensors can be used so long as the position of the detection plate 110 relative to the yoke 108 can be ascertained. As shown in FIG. 1, a bottom surface 132 of the detection plate 110 may protrude by a distance (X) from the lower surface 134 of the yoke 108 when the inward facing flanges 112 and outward facing flanges 114 are in an abutting relationship. Furthermore, a distance (Y) may exist between the detection plate 110 and the sensors 130 when the inward facing flanges 112 and outward facing flanges 114 are in an abutting relationship.

The pick-up head assembly 106 may raise and lower above the nest assembly 102 to pick and place a green sheet or detect debris on the surface of the green sheet. When no debris is present on the green sheet the detection plate 110 may lay flat on the surface of the green sheet. When debris may be present either above or below the green sheet the detection plate 110 may not sit flat on the surface of the green sheet.

Now referring to FIG. 2, the pick-up assembly 106 may be lowered on top of the nest assembly 102 illustrating the sensor set position when no debris is present. The locating pins 104 of the nest assembly 102 may engage with the alignment holes 116 (shown in FIG. 1) in the yoke 108 to assure proper alignment of the yoke 108 relative to the nest assembly 102. In particular, a green sheet 136 supported by a film material 138 may be positioned on the nest assembly 102. The green sheet 136 may contain a template of thru-holes (for example vias) and the film material 138 may prevent the screened on paste from permeating through the vias and coming in contact with the nest assembly 102. In one embodiment, the film material 138 may be “Melinex” or another commercially available film. With the green sheet 136 and film material 138 positioned on the nest assembly 106, and the nest assembly 106 positioned below the pick-up head assembly 106, the pick-up head assembly 106 may be lowered and the detection plate 110 may rest substantially uniform on the green sheet 136. The sensors 130 may therefore be disposed a uniform distance (Y) above the plate. Stated differently, there should be no variation in dimension (Y) between the upper surface of the detection plate 110 and any of the sensors 130 shown in FIG. 2.

Now referring to FIG. 3, the yoke 108 may be lowered on top of the nest assembly 102 illustrating the presence and detection of a piece of debris 140 on the green sheet 136. If debris is present, as shown in the figure, the detection plate 110 will be displaced upward in the vicinity of the piece of debris 140. The sensor set dimensions (Y) may not be maintained such that a variation in output will exist between two different sensors 130. This output may be used to indicate the presence of the piece of debris 140 on the surface of the green sheet 136. Therefore, the green sheet 136 should be rejected and cleaned prior to subsequent processing.

The sensors 130 may include, for example, air gauges, linear variable differential transformer (LVDT), mechanical or other proximity sensors. It is also apparent that contact or non-contact type sensors may be used. Sensor output would typically be processed via typical signal processing techniques associated with a pick-up head reference point, and sensor outputs as a function of the sensor set dimension (Y).

Alternatively, in one embodiment the sensors 130 may be positioned in the detection plate 110. In this embodiment, the sensors 130 may detect the distance between the detection plate and the upper surface on the green sheet 136.

FIG. 3 illustrates a situation where debris may be carried by the green sheet 136. It may be understood, however, that the embodiment is equally applicable to detect and eliminate the presence of debris which exists on the nest assembly 102 or between the green sheet 136 and the film material 138.

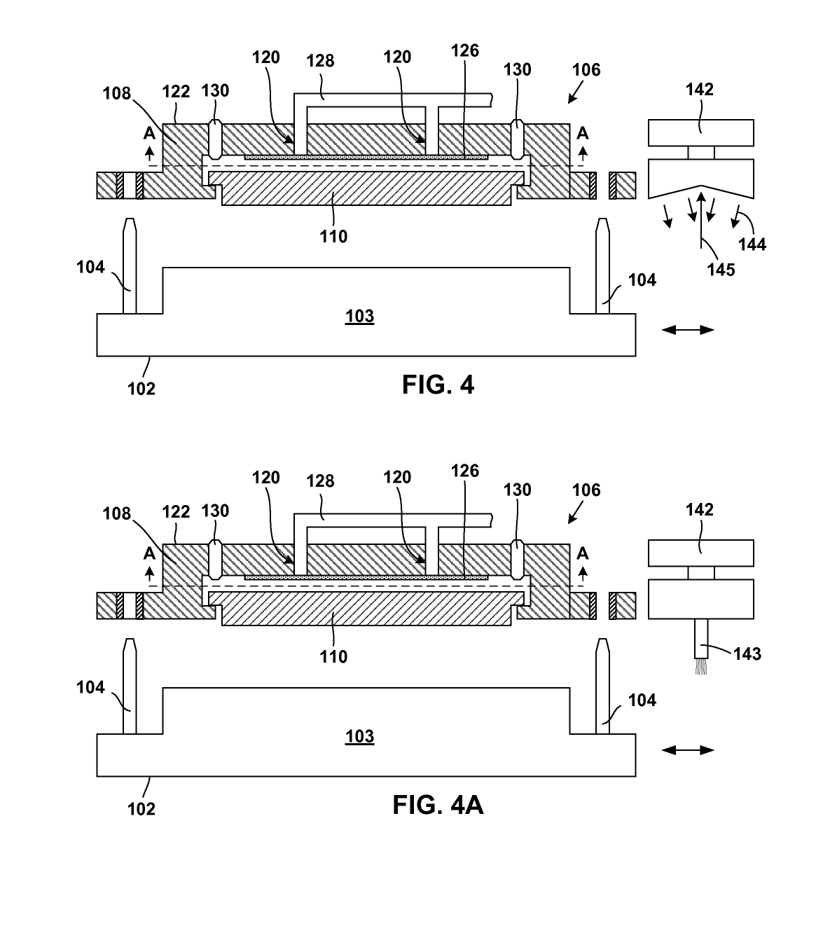

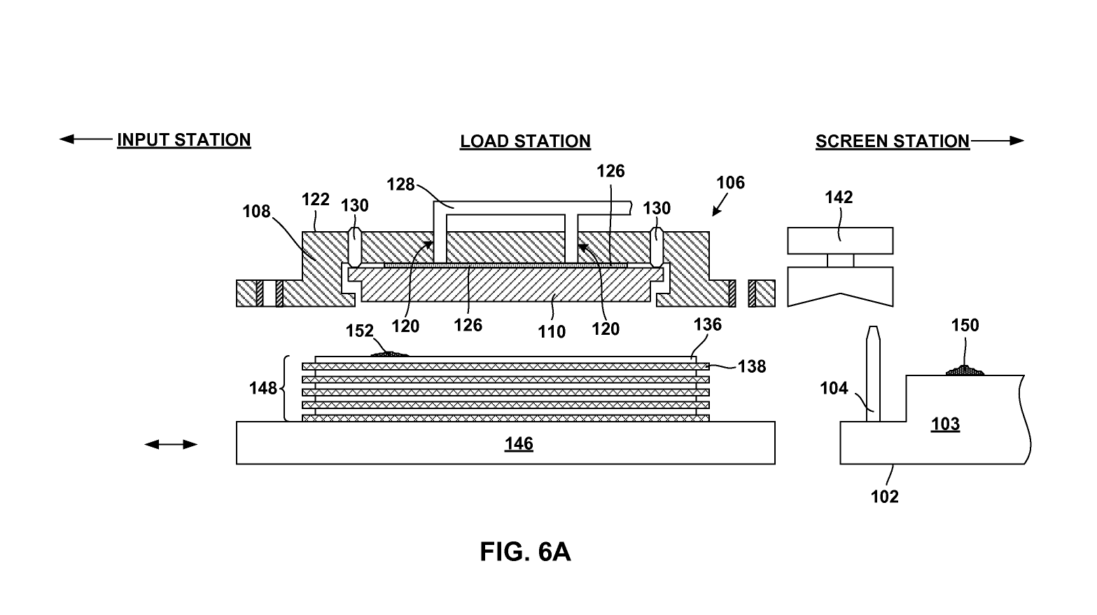

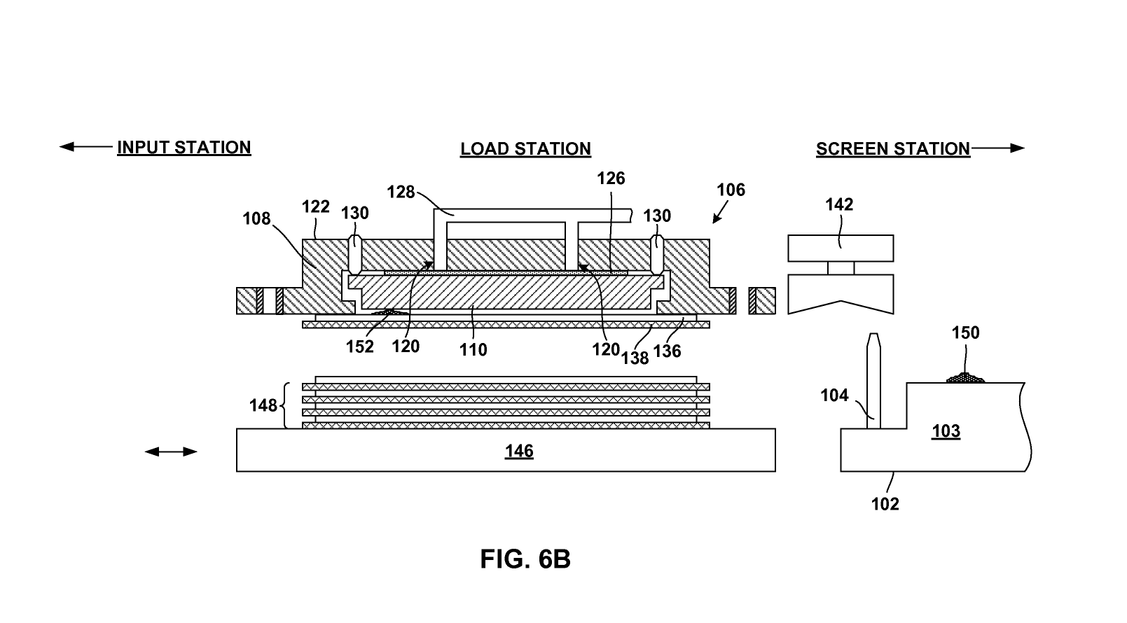

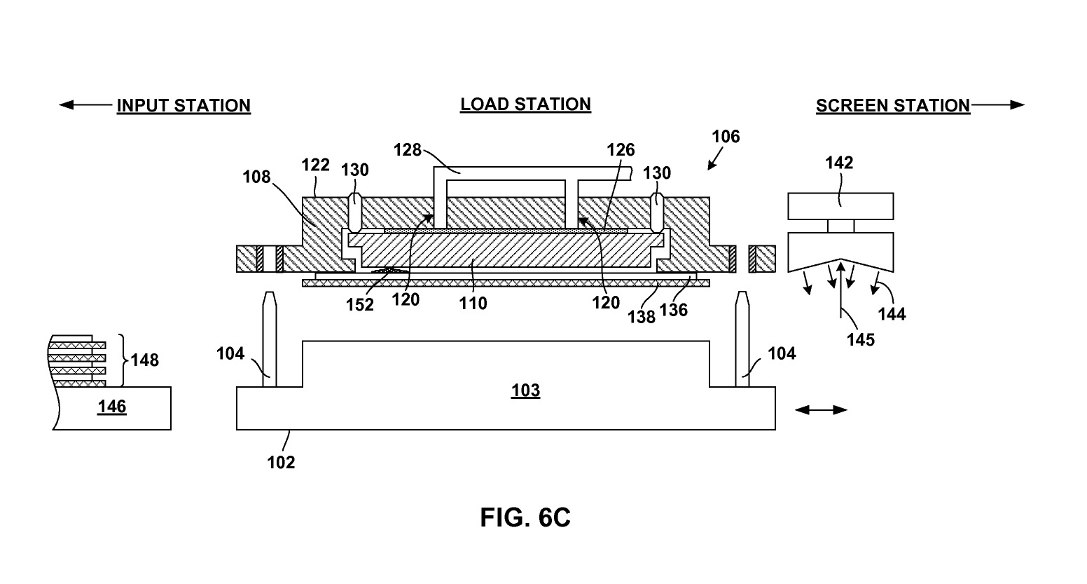

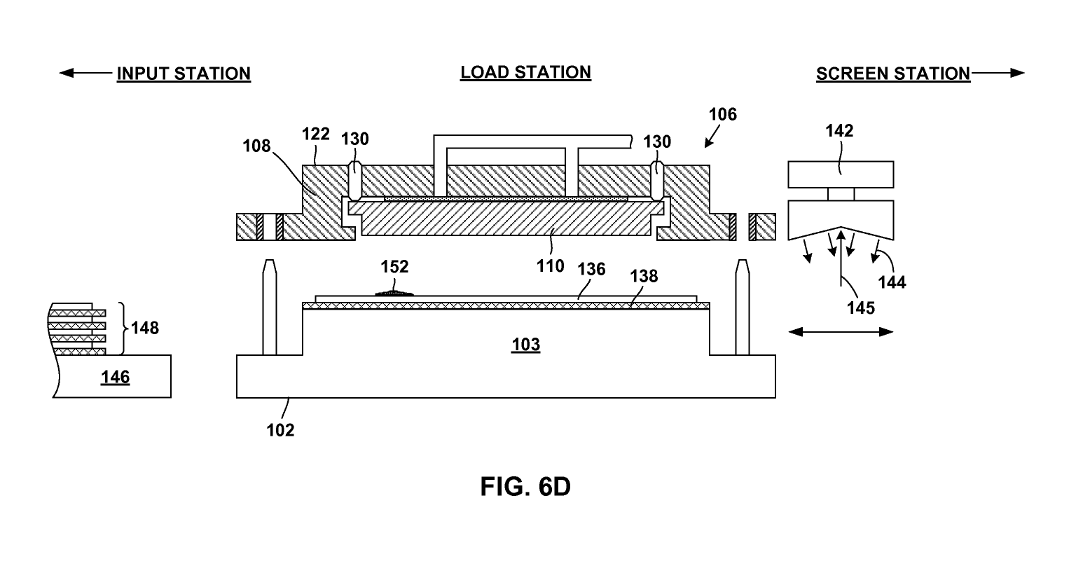

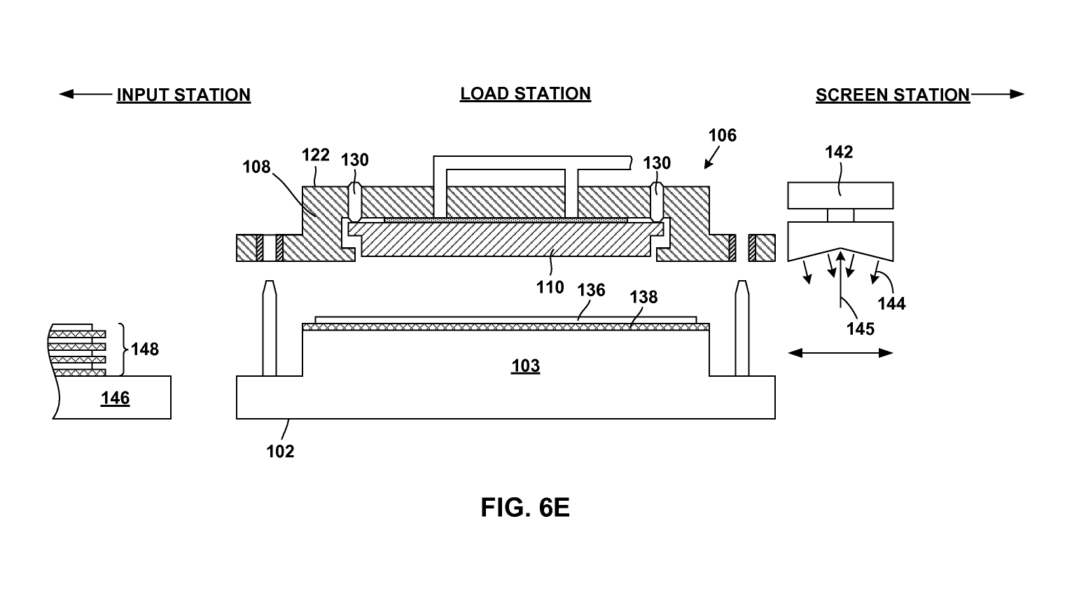

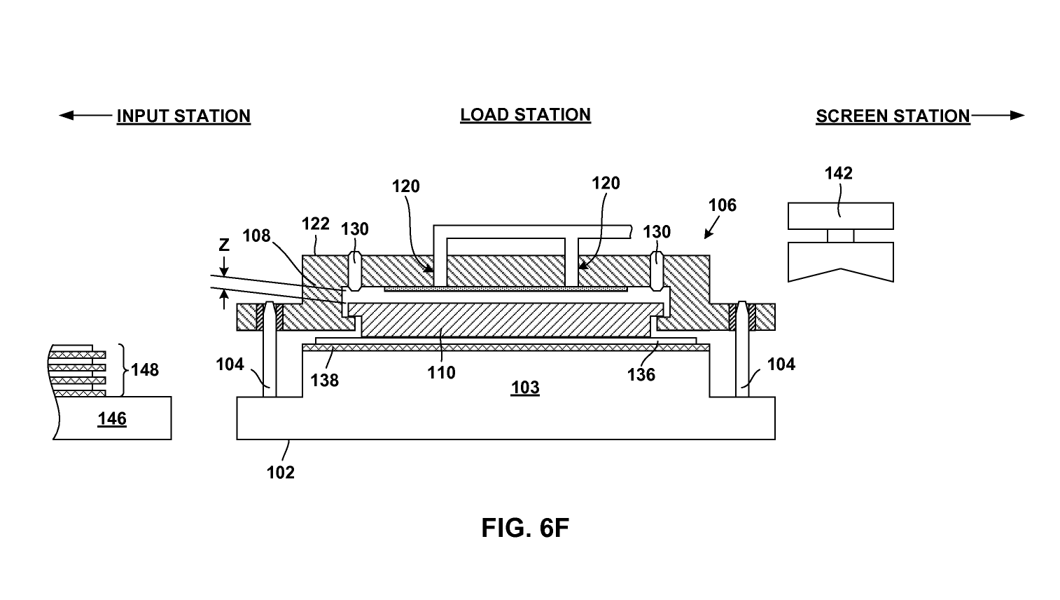

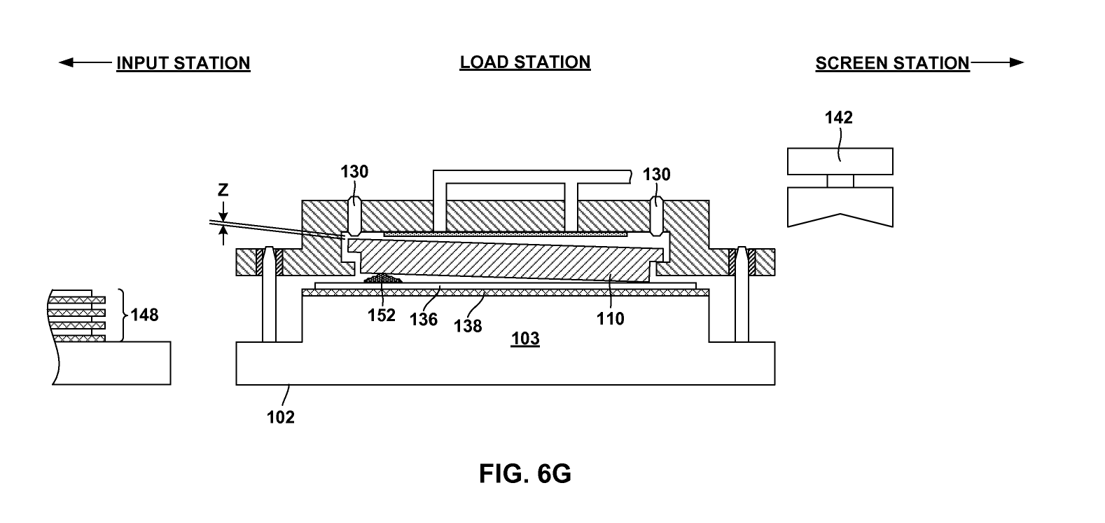

Now referring to FIG. 4, a sheet and nest cleaning device 142 (hereinafter referring to as cleaning device 142) is shown positioned adjacent to the pick-up head assembly 106 and in-line with the travel of the nest assembly 102. The cleaning device 142 may be positioned above the nest assembly 102. During a cleaning sequence, the cleaning device 142 may direct compressed air 144 in a plurality of directions at the nest assembly 102. In addition to the compressed air 144 used to loosen debris, a vacuum 145 may be located in the center of the cleaning device 142 which may be used to remove the debris. In one embodiment, the cleaning device 142 may itself travel vertically to facilitate up close cleaning of the nest assembly 102 or a green sheet located on the nest assembly 102. The cleaning method is described in greater detail below (see FIGS. 6A-6G). In one embodiment, the cleaning device 142 may include a sweeper, as shown in FIG. 4A, with soft plastic bristles. The sweeper may be used to brush debris from the surface of the green sheet 136 or the nest assembly 102.

Now referring to FIG. 5, a cross-sectional view of FIG. 4, section A-A, in which the pneumatic ports 120, the film chamber 126, and the sensors 130 are shown. Four pneumatic ports 120 are shown, but as described above, any sufficient number of pneumatic ports in any sufficient configuration may be used. Similarly, four sensors 130 are shown, but any sufficient number of sensors able to detect some variation in the detection plate 110 may be used. The film chamber 126 may have a octagonal shape, although any sufficient shape may be used.

Referring now to FIGS. 6A-6G, exemplary process steps of cleaning and contamination detection of a loadhead assembly system in accordance with one embodiment of the present invention are shown. The loadhead assembly system may include three process stations, an input station, a load station, and a screen station. The three process stations may be in-line with one another with the load station being situated between the input station and the screen station. These three process stations may be referred to collectively as a process stream. The input station is where new green sheets may be introduced into the process stream. Specifically, an input tray shuttle moves from the input station to the load station where a pick-up head assembly picks up a green sheet and a film material. A detection plate located within the pick-up head assembly may be retracted during picking of the green sheet. The input tray shuttle may then move from the load station back to the input station. Next, a nest assembly moves from the screen station to the load station during which the surface of the nest assembly may be cleaned by a cleaning device. The pick-up head assembly places the green sheet and film material onto the nest assembly. The nest assembly, with the green sheet and film material, may move from the load station to the screen station and back to the load station during which a top surface of the green sheet may be cleaned. Next, the detection plate may be lowered within the pick-up head assembly and the pick-up head assembly may be lowered on top of the green sheet to initiate debris detection. Cleaning prior to debris detection may help eliminate debris from being compressed into the surface of the green sheet by the weight of the detection plate.

Now referring to FIG. 6A, an input tray shuttle 146, loaded with a stack 148 of green sheets and film materials, may travel from an input station to a load station. Before picking a green sheet 136 and a film material 138 the detection plate 110 may be retracted into the yoke 108 by applying a suitable amount of vacuum to the hose 128, as shown in the figure. Preferably, a vacuum of at least about 20 inHg to about 25 inHg may be required to lift a detection plate weighing about 5 lbs. The vacuum applied to the hose 128 may be delivered to the pneumatic ports 120 and film chamber 126 causing the detection plate 110 to retract against the film chamber 126. Vacuum pressure may be maintained using, for example, a solenoid valve (not shown) or alternatively by applying continuous vacuum to the hose 128. At this time, a piece of debris 150 may be present on the surface of the nest assembly 102.

Now referring to FIG. 6B, the green sheet 136 and film material 138 may be picked up and raised by the pick-up head assembly 106. As described above, the pick-up head assembly 106 may use vacuum or Bernouilli principles to lift the green sheet 136 and film material 138 during processing. Once the green sheet 136 and film material 138 have been lifted, the input tray shuttle 146 may return to the input station.

Now referring to FIG. 6C, the nest assembly 102 may be shuttled from the screen station to the load station all while passing beneath the cleaning device 142. As the nest assembly 102 passes beneath the cleaning device 142, the compressed air 144 and vacuum 145 may remove, for example, the piece of debris 150 (shown in FIG. 6A) from the surface of the nest assembly 102.

Now referring to FIG. 6D, the pick-up assembly 106 may lower and deposit the green sheet 136 and the film material 138 on the nest assembly 102. In some cases, a piece of debris 152 may exist within an active area on the surface of the green sheet 136, as shown in the figure. The active area of the green sheet 136 may be the area in which the detection plate 110 rests during its detection sequence. The piece of debris 152 may be introduced into the process stream at any time and by any mode, and the existence of the piece of debris 152 is relevant, not how or when it may have been introduced. The piece of debris 152 may preferably be removed from the active area of the green sheet prior to initiating the detection sequence or else the piece of debris 152 may be compressed into the surface of the green sheet 136. Generally, debris compressed into the surface of a green sheet may result in a defective green sheet. It may be understood that debris located outside the active area of the green sheet 136 may be less problematic for subsequent fabrication processes and future green sheet operation.

Now referring to to FIG. 6E, the nest assembly 102, with the green sheet 136 and the film material 138, may then be shuttled to the screen station and back to the load station all while passing beneath the cleaning device 142. As the green sheet 136 passes beneath the cleaning device 142, the compressed air 144 may free the debris 152 (shown in FIG. 6D) and the vacuum 145 may remove the debris 152 (shown in FIG. 6D) from the surface of the green sheet 136.

Now referring to FIG. 6F, the detection sequence may be initiated. First, the vacuum pressure used to raised the detection plate 110 may be released and allow the detection plate 110 to move freely, or float, within the confines of the yoke 108. In one embodiment, the hose 128 may be supplied with compressed air to break any residual vacuum between the film chamber 126 and the detection plate 110. The pick-up assembly 106 may then be lowered on top of the nest assembly 102. As described above, the locating pins 104 of the nest assembly 102 may engage with the alignment holes 116 (shown in FIG. 1) in the yoke 108 to assure proper alignment of the yoke 108 relative to the nest assembly 102. The detection plate 110 may rest on the green sheet 136. The sensors 130 may therefore be disposed at some distance (Z) above the plate. In the case where the cleaning device 142 was successful in removing the piece of debris 152 the detection plate 110 may rest substantially uniform on the green sheet 136, and there may be no variation in dimension (Z) between the upper surface of the detection plate 110 and any of the sensors 130, as shown in the figure.

Now referring to FIG. 6G, the case where cleaning sequence was unsuccessful and the piece of debris 152 may remain on the surface of the green sheet 136, is shown. In such cases, the detection plate 110 may not sit uniform causing some variation in dimension (Z) between various sensors 130. In one embodiment, upon some indication that the piece of debris 152 may remain on the surface of the green sheet 136 another cleaning sequence may be initiated. Alternatively, the green sheet 136 with the piece of debris 152 may be rejected from processing for off-line cleaning.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A system comprising:
a shuttle movable along a shuttle path, the shuttle being operable to support a sheet;
a pick-up assembly comprising a yoke and a detection plate located above the shuttle path, the detection plate being freely supported by the yoke and movable in a vertical direction relative to the yoke with an upper limit and a lower limit defined by the yoke, wherein the yoke is operable to pick and place the sheet, and wherein the detection plate is used to detect the presence of a piece of debris on a surface of the sheet or a surface of the shuttle; and
a pneumatic system to raise the detection plate to the upper limit or lower the detection plate to the lower limit.

2. The structure of claim 1, further comprising:
a cleaning device located adjacent to the pick-up assembly and above the shuttle path, wherein the cleaning device is operable to remove the piece of debris located on the surface of the sheet or the surface of the shuttle.

3. The system of claim 1, wherein the detection plate is recessed relative to the yoke at the upper limit of travel and is protruding downward relative to the yoke at the lower limit of travel.

4. The system of claim 1, wherein the cleaning device travels up and down vertically above the shuttle path.

5. The system of claim 1, wherein the cleaning device uses compressed air to free the piece of debris and a vacuum to remove the piece of debris from the surface of the sheet or the surface of the shuttle.

6. The system of claim 1, wherein the cleaning device uses a sweeper to remove the piece of debris from the surface of the sheet or the surface of the shuttle, wherein the sweeper may comprise plastic bristles.

7. The system of claim 1, further comprising:
a series of sensors to detect the vertical position of a plurality of points on the detection plate relative to the yoke.

8. The system of claim 1, wherein the shuttle further comprises a locating pin and the pick-up assembly further comprises a hole aligned with the locating pin.

9. The system of claim 1, wherein the sheet is a flexible unfired thin ceramic sheet.

10. A method comprising:
cleaning a shuttle by moving the shuttle along a shuttle path below a cleaning assembly;
placing a sheet on the shuttle using a pick-up assembly comprising a detection plate; the detection plate being freely supported by a yoke and movable in a vertical direction relative to the yoke with an upper limit and a lower limit defined by the yoke;
cleaning the sheet by moving the shuttle with the sheet along the shuttle path below the cleaning assembly; and
checking for a piece of debris by lowering the pick-up assembly and resting the detection plate on the sheet.

11. The method of claim 10, wherein placing the sheet on the shuttle the detection plate is recessed relative to the yoke at the upper limit of travel.

12. The method of claim 10, wherein checking for debris the detection plate is protruding downward relative to the yoke at the lower limit of travel.

13. The method of claim 10, wherein the cleaning device travels up and down vertically above the shuttle path.

14. The method of claim 10, wherein the cleaning device uses compressed air to free the piece of debris and a vacuum to remove the piece of debris from the surface of the sheet or the surface of the shuttle.

15. The method of claim 10, wherein the cleaning device uses a sweeper to remove debris from the surface of the sheet or the surface of the shuttle, wherein the sweeper may comprise plastic bristles.

16. The method of claim 10, further comprising:
detecting the vertical position of a plurality of points on the detection plate relative to the yoke using a series of sensors.

17. The method of claim 10, wherein the pick-up assembly further comprises a pneumatic system to raise the detection plate to the upper limit or lower the detection plate to the lower limit.

18. The method of claim 10, wherein the shuttle further comprises a locating pin and the pick-up assembly further comprises a hole aligned with the locating pin.

19. The method of claim 10, wherein the sheet is a flexible unfired thin ceramic sheet.
